(19) United States
(12) Patent Application Publication
(10) Pub. No.: US 2014/0375541 A1
(43) Pub. Date: Dec. 25, 2014

(54) EYE TRACKING VIA DEPTH CAMERA

(71) Applicants: David Nister, Bellevue, WA (US); Ibrahim Eden, Kirkland, WA (US)

(72) Inventors: David Nister, Bellevue, WA (US); Ibrahim Eden, Kirkland, WA (US)

(21) Appl. No.: 13/926,223

(22) Filed: Jun. 25, 2013

(51) Int. Cl. G06F 3/01; G06F 3/03

(52) U.S. Cl. CPC G06F 3/013; G06F 3/0304
USPC 345/156

(57) ABSTRACT

Embodiments are disclosed that relate to tracking a user's eye based on time-of-flight depth image data of the user's eye are disclosed. For example, one disclosed embodiment provides an eye tracking system comprising a light source, a sensing subsystem configured to obtain a two-dimensional image of a user's eye and depth data of the user's eye using a depth sensor having an unconstrained baseline distance, and a logic subsystem configured to control the light source to emit light, control the sensing subsystem to acquire a two-dimensional image of the user's eye while illuminating the light source, control the sensing subsystem to acquire depth data of the user's eye, determine a gaze direction of the user's eye from the two-dimensional image, determine a location on a display at which the gaze direction intersects the display based on the gaze direction and the depth data, and output the location.

### BACKGROUND

Real-time eye tracking may be used to estimate and map a user's gaze direction to coordinates on a display device. For example, a location on a display at which a user's gaze direction intersects the display may be used as a mechanism for interacting with user interface objects displayed on the display. Various methods of eye tracking may be used. For example, in some approaches, light, e.g., in the infrared range or any other suitable frequency, from one or more light sources may be directed toward a user's eye, and a camera may be used to capture image data of the user's eye. Locations of reflections of the light on the user's eye and a position of the pupil of the eye may be detected in the image data to determine a direction of the user's gaze. Gaze direction information may be used in combination with information regarding a distance from the user's eye to a display to determine the location on the display at which the user's eye gaze direction intersects the display.

### SUMMARY

Embodiments related to eye tracking utilizing time-of-flight depth image data of the user's eye are disclosed. For example, one disclosed embodiment provides an eye tracking system comprising a light source, a sensing subsystem configured to obtain a two-dimensional image of a user's eye and depth data of the user's eye, and a logic subsystem to control the light source to emit light, control the sensing subsystem to acquire a two-dimensional image of the user's eye while emitting light from the light source, control the sensing subsystem to acquire depth data of the user's eye, determine a gaze direction of the user's eye from the two-dimensional image, determine a location on a display at which the user's gaze intersects the display based on the gaze direction and the depth of the user's eye obtained from the depth data, and output the location.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A-4 show example eye tracking scenarios.

FIG. 5 shows an embodiment of an eye tracking module in accordance with the disclosure.

FIG. 6 illustrates an example of eye tracking based on time-of-flight depth image data in accordance with an embodiment of the disclosure.

FIG. 7 shows an embodiment of a method for tracking a user's eye based on time-of-flight depth image data.

FIG. 8 schematically shows an embodiment of a computing system.

### DETAILED DESCRIPTION

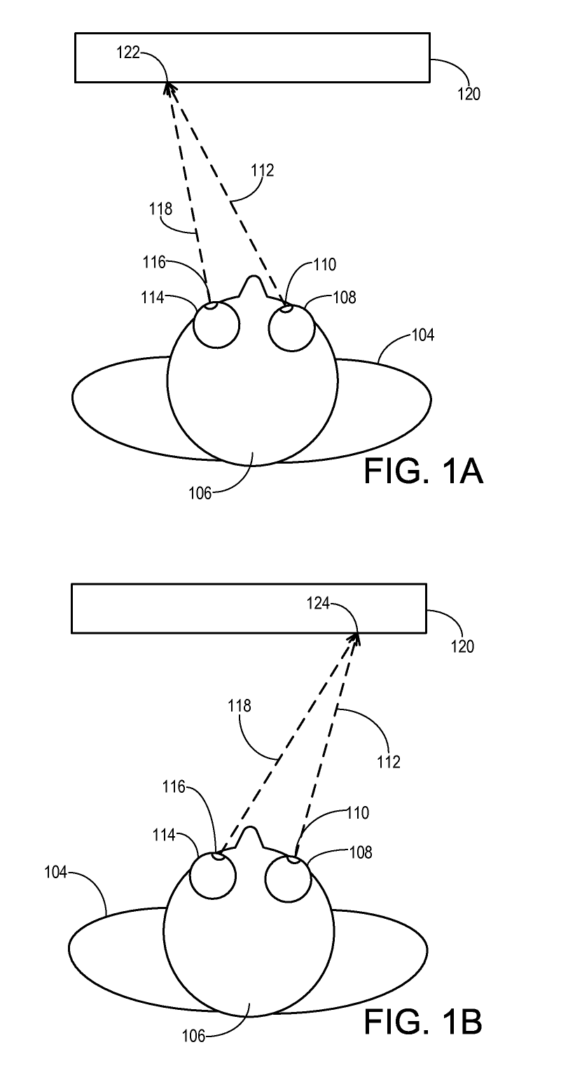

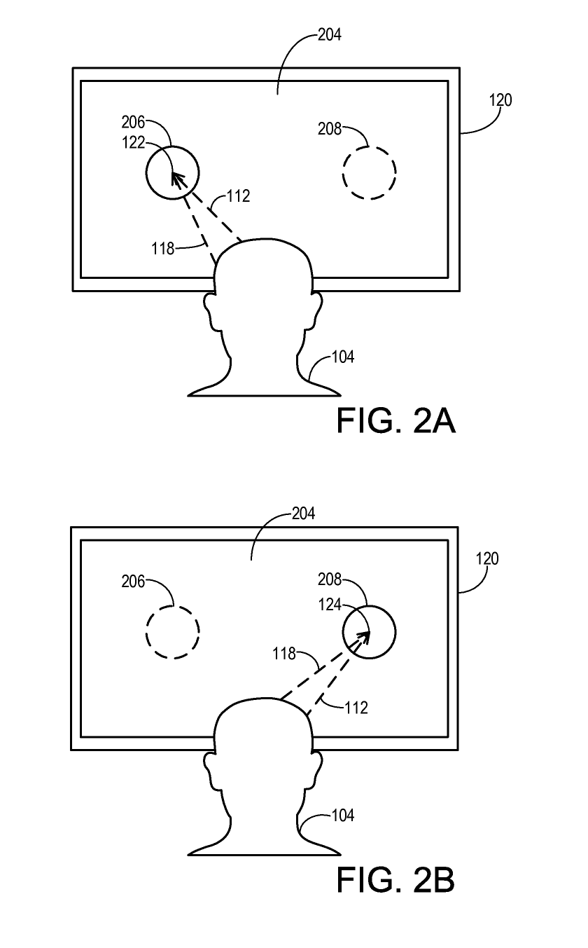

As described above, eye tracking may be used to map a user's gaze to a user interface displayed on a display device based upon an estimated location at which the gaze intersects the display device. The location at which a user's gaze direction intersects the display device thus may act as a user input mechanism for the user interface. FIGS. 1A-2A and 1B-2B schematically depict an example scenario (from top and front views respectively) in which a user 104 gazes at different locations on a display device 120. Display device 120 may schematically represent any suitable display device, including but not limited to a computer monitor, a mobile device, a television, a tablet computer, a near-eye display, and a wearable computer. User 104 includes a head 106, a first eye 108 with a first pupil 110, and a second eye 114 with a second pupil 116, as shown in FIG. 1A. A first eye gaze direction 112 indicates a direction in which the first eye 108 is gazing and a second eye gaze direction 118 indicates a direction in which the second eye 114 is gazing.

FIGS. 1A and 2A show the first eye gaze direction 112 and the second eye gaze direction 118 converging at a first location of focus 122 on display device 120. FIG. 2A also shows a first user interface object 206 intersected by the first eye gaze direction 112 and the second eye gaze direction 118 at the first location of focus 122. Next, FIGS. 1B and 2B show the first eye gaze direction 112 and the second eye gaze direction 118 converging at a second location of focus 124 due to a rotation of eyes 114 and 108 from a direction toward the left side of display device 120 to a direction toward a right side of display device 120. FIG. 2B also shows a second user interface object 208 intersected by the first eye gaze direction 112 and the second eye gaze direction 118 at the second location of focus 124. Thus, by tracking the user's gaze, a position signal may be generated as a user interface input based upon the location at which the user's gaze intersects the display device, thereby allowing the user to interact with the first user interface object 204 and the second user interface object 208 at least partially through gaze.

Eye tracking may be performed in a variety of ways. For example, as described above, glints light from calibrated light sources reflected from a user's eyes, together with detected or estimated pupil locations of the user's eyes, may be used to determine a direction of the user's gaze. A distance from the user's eyes to a display device may then be estimated or detected to determine the location on the display at which the user's gaze direction intersects the display. As one example, stereo cameras having a fixed or otherwise known relationship to the display may be used to determine the distance from the user's eyes to the display. However, as described below, stereo cameras may impose geometric constraints that make their use difficult in some environments.

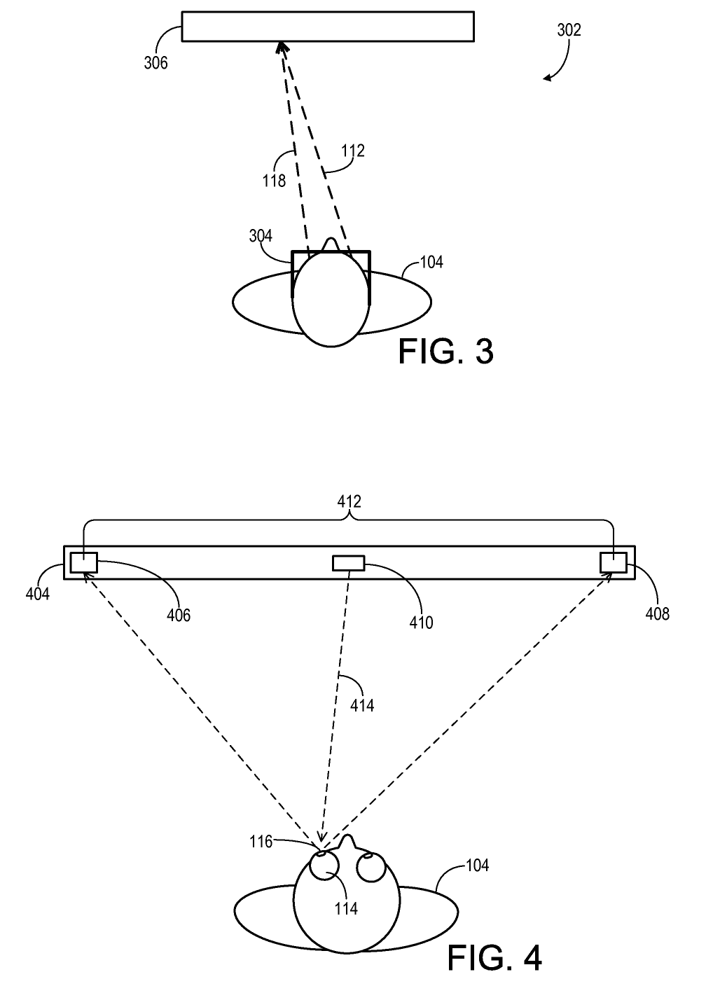

Eye tracking may be used in a variety of different hardware environments. For example, FIG. 3 shows a user 104 wearing a wearable computing device 304, depicted as a head-mounted augmented reality display device, and gazing at an object 306 in an environment 302. In this example, device 304 may comprise an integrated eye tracking system to track the user's gaze and detect interactions with virtual objects displayed on device 304, as well as with real world objects in a background viewable through the wearable computing device 304. FIG. 4 depicts another example of an eye tracking hardware environment, in which eye tracking is used to detect a location on a computer monitor 404 at which a user is gazing.

In these and/or other hardware settings, the accuracy and stability of the eye tracking system may be dependent upon obtaining an accurate estimate of the distance of the eye from the camera plane. Current eye tracking systems may solve this problem through the use of a stereo camera pair to estimate the three-dimensional eye position using computer vision algorithms. FIG. 4 illustrates a stereo camera configuration as including a first camera 406 and a second camera 408 separated by a baseline distance 412. FIG. 4 also illustrates a light source 410 that may be illuminated to emit light 414 for reflection from eye 114. Images of the user's eyes (whether acquired by the stereo camera image sensors or other image sensor(s)) may be employed to determine a location of the reflection from eye 114 relative to a pupil 116 of the eye to determine a gaze direction of eye 114. Further, images of the eye from the first camera 406 and the second camera 408 may be used to estimate a distance of the eye 114 from the display 402 so that a location at which the user's gaze intersects the display may be determined.

However, the baseline distance 412 between the first camera 406 and second camera 408 may be geometrically constrained to being greater than a threshold distance (e.g., greater than 10 cm) for accurate determination (triangulation) of the distance between the user's eye 114 and the display 402. This may limit the ability to reduce the size of such an eye tracking unit, and may be difficult to use with some hardware configurations, such as a head-mounted display or other compact display device.

Other approaches to determining a distance between a user's eye and a display may rely on a single camera system and utilize a weak estimation of the eye distance. However, such approaches may result in an unstable mapping between actual gaze location and screen coordinates.

Accordingly, embodiments are disclosed herein that relate to the use of a depth sensor having an unconstrained baseline distance (i.e. no minimum baseline distance, as opposed to a stereo camera arrangement) in an eye tracking system to obtain information about location and position of a user's eyes. One example of such a depth sensor is a time-of-flight depth camera. A time-of-flight depth camera utilizes a light source configured to emit pulses of light, and one or more image sensors configured to be shuttered to capture a series of temporally sequential image frames timed relative to a corresponding light pulse. Depth at each pixel of an image sensor in the depth camera, i.e., the effective distance that light from the light source that is reflected by an object travels from the object to that pixel of the image sensor, may be determined based upon a light intensity in each sequential image, due to light reflected from objects at different depths being captured in different sequential image frames.

As a time-of-flight depth camera may acquire image data from a single location, rather than from two locations as with a stereo pair of image sensors, an eye tracking system utilizing a time-of-flight depth camera may not have minimum baseline dimensional constraints as found with stereo camera configurations. This may allow the eye tracking system to be more easily utilized in hardware configurations such as head-mounted displays, smart phones, tablet computers, and other small devices where sufficient space for a stereo camera eye tracking system may not be available. Other examples of depth sensors with unconstrained baseline distances may include, but are not limited to, LIDAR (Light Detection and Ranging) and sound propagation-based methods.

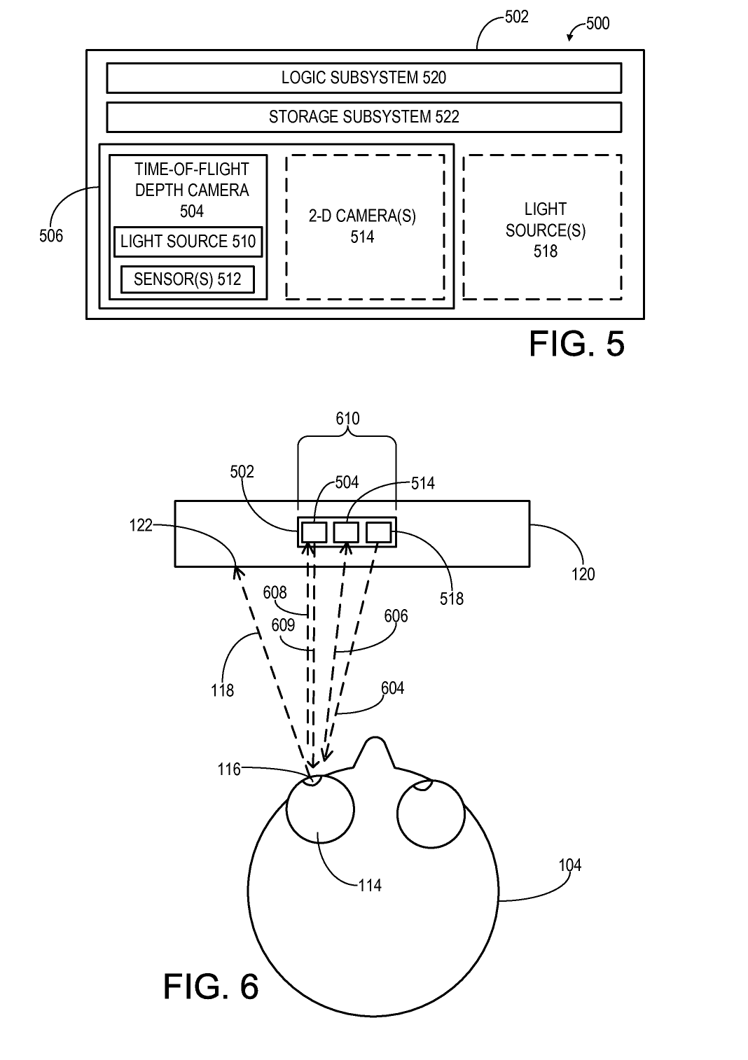

FIG. 5 shows an example eye tracking module 500 which utilizes a time-of-flight depth camera for eye tracking. The depicted eye tracking module 500 may include a body 502 which contains or otherwise supports all of the components described below, thereby forming a modular system. Due to the use of a time-of-flight depth camera 504, a size of the body 502 may be greatly reduced compared to a comparable stereo camera eye tracking system. In some examples, the eye tracking module 500 may be integrated with a display device, e.g., such as a mobile computing device or a wearable computing device. In such examples, the eye tracking module 500 and/or components thereof may be supported by the display device body. In other examples, the eye tracking module may be external from a computing device to which it provides input and/or external to a display device for which it provides a position signal. In such examples, the body 502 may enclose and/or support the components of the eye tracking system to form a modular component that can be easily installed into other devices, and/or used as a standalone device.

Eye tracking module 500 includes a sensing subsystem 506 configured to obtain a two-dimensional image of a user's eye and also depth data of the user's eye. For example, the sensing subsystem 506 may include a time-of-flight depth camera 504, where the time-of-flight depth camera 504 includes a light source 510 and one or more image sensors 512. As described above, the light source 510 may be configured to emit pulses of light, and the one or more image sensors may be configured to be shuttered to capture a series of temporally sequential image frames timed relative to a corresponding light pulse. Depth at each pixel, i.e., the effective distance that light from the light source that is reflected by an object travels from the object to that pixel of the image sensor, may be determined based upon a light intensity in each sequential image, due to light reflected from objects at different depths being captured in different sequential image frames. It will be appreciated that any other depth sensor having an unconstrained baseline distance may be used in other embodiments instead of, or in addition, to the time-of-flight depth camera 504.

In some examples, the image sensor(s) 512 included in depth camera 504 also may be used to acquire two-dimensional image data (i.e. intensity data as a function of horizontal and vertical position in a field of view of the image sensor, instead of depth) to determine a location of a reflection and a pupil of a user's eye, in addition to depth data. For example, all of the sequential images for a depth measurement may be summed to determine a total light intensity at each pixel. In other embodiments, one or more separate image sensors may be utilized to detect images of the user's pupil and reflections of light source light from the user's eye, as shown by two-dimensional camera(s) 514.

In some embodiments, a single two-dimensional camera 514 may be used along with a time-of-flight depth camera. In other embodiments, the sensing subsystem 506 may utilize more than one two-dimensional camera, in addition to a time-of-flight depth camera. For example, the sensing subsystem 506 may utilize a first two-dimensional camera to obtain a relatively wider field of view image to help locate a position of the eyes of a user. This may help to find and track eye sockets of the user, so that regions of the user containing the user's eyes may be identified. Further, a second two-dimensional camera may be used to capture a higher resolution image of a narrower field of view directed at the identified regions of the user's eye to acquire eye-tracking data. By roughly identifying eye location in this manner, the spatial region that is analyzed for pupil and corneal pattern detection may be reduced in the higher resolution image, as non-eye regions as determined from the lower resolution image data may be ignored when analyzing the higher resolution image data.

In some embodiments, the depth camera may operate in the infrared range and the additional camera 514 may operate in the visible range. For example, an eye-tracking module may consist of a depth camera and a visible range high-resolution camera (e.g., a front facing camera on a slate).

In some embodiments, the eye tracking module 500 also may include a light source 518 to provide light for generating corneal reflections that is different from the light source 510 of depth camera 504. Any suitable light source may be used as a light source 518. For example, light source 518 may comprise one or more infrared light-emitting diodes (LED) positioned at any suitable position relative to an optical axis of a user gazing forward. Any suitable combination of light sources may be used, and the light sources may be illuminated in any suitable temporal pattern. In other embodiments, the light source 510 of the time-of-flight depth camera 504 may be configured to be used as a light source for reflecting light from a user's eye. It will be understood that these embodiments are described for the purpose of example, and are not intended to be limiting in any manner.

Eye tracking module 500 further includes a logic subsystem 520 and a storage subsystem 522 comprising instructions stored thereon that are executable by the logic subsystem to perform various tasks, including but not limited to tasks related to eye tracking and to user interface interactions utilizing eye tracking. More detail regarding computing system hardware is described below.

FIG. 6 shows a schematic depiction of eye tracking based on time-of-flight depth image data via eye tracking module 500. As depicted, the depth camera 504, two-dimensional camera 514, and light source 518 are part of an integrated module, but may take any other suitable form. In some examples, eye tracking module 500 may be integrated with a display device 120, such as a mobile device, a tablet computer, a television set, or a head mounted display device. In other examples, eye tracking module 500 may be external to display device 120.

FIG. 6 also illustrates an example of a determination of a location at which a gaze direction 118 intersects a display device 120. Light source(s) 518, e.g., an infrared LED positioned on or off axis, may be illuminated so that emitted light 604 from the light source(s) creates a reflection on the user's eye 114. The light source(s) also may be used to create a bright pupil response in the user's eye 114 so that the pupil may be located, wherein the term “bright pupil response” refers to the detection of light from light source 510 or light source 518 reflected from the fundus (interior surface) of the user's eye (e.g. the “red-eye” effect in photography). In other examples, the pupil may be located without the use of a bright pupil response. Further, in some examples, different types of illumination, optics, and/or cameras may be used to assist in distinguishing a reflection on top of a bright pupil response. For example, different wavelengths of light emitted from a light source may be used to optimize light source reflection response and bright pupil response.

In order to determine a rotation of the user's eye 114, each reflection provides a reference with which the pupil can be compared to determine a direction of eye rotation. As such, the two-dimensional camera 514 may acquire two-dimensional image data of the reflection as reflected 606 from the user's eye. The location of the pupil 116 of the user's eye 114 and the light reflection location may be determined from the two-dimensional image data. The gaze direction 118 may then be determined from the location of the pupil and the location of the reflection.

Further, the depth camera 504 may acquire a time-of-flight depth image via light reflected 608 from the eye that arises from a light pulse 609 emitted by the depth camera light source. The depth image then may be used to detect a distance of the user's eye from the display. The angle or positioning of the depth camera 504 with respect to the display 120 may be fixed, or otherwise known (e.g. via a calibration process). Thus, the two-dimensional image data and depth data may be used to determine and output a location at which the gaze direction intersects the display.

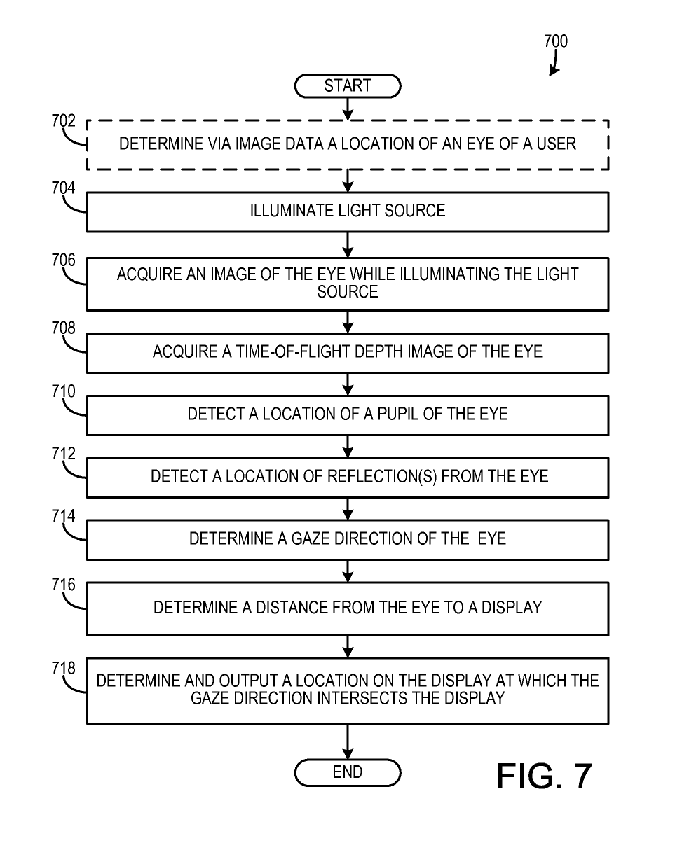

FIG. 7 shows a flow diagram depicting an example embodiment of a method 700 for performing eye tracking utilizing time-of-flight depth image data. It will be understood that method 700 may be implemented in any suitable manner. For example, method 700 may represent a continuous operation performed by an eye-tracking module and, in some examples, one or more steps of method 700 may be performed in parallel by different components of the eye-tracking module. Method 700 may optionally include, at 702, determining via image data a location of an eye of a user, for example, via pattern recognition or other suitable method(s). For example, a wide field of view camera may be used to steer a narrow field of view camera to get a more detailed image of the eye region.

At 704, method 700 includes illuminating a light source to emit light from the light source. Any suitable light source may be used. For example, the light source may comprise one or more infrared light-emitting diodes (LED) positioned on or off axis. Any suitable combination of on-axis and off-axis light sources may be used, and the light sources may be illuminated in any suitable temporal pattern. Further, in some examples, the light source may comprise a light source incorporated in a time-of-flight depth camera. It will be understood that these embodiments are described for the purpose of example, and are not intended to be limiting in any manner.

Method 700 further includes, at 706, acquiring an image of the eye while emitting light from the light source. For example, a two-dimensional image of the eye may be obtained via a dedicated two-dimensional camera, or time-of-flight depth data may be summed across all sequentially shuttered images for a depth measurement. Further, at 708, method 700 includes acquiring a time-of-flight image of the eye, for example, via a time-of-flight depth camera, or otherwise acquiring depth data of the eye via a suitable depth sensor having an unconstrained baseline distance.

At 710, method 700 includes detecting a location of a pupil of the eye from the two dimensional data. Any suitable optical and/or image processing methods may be used to detect the location of the pupil of the eye. For example, in some embodiments, a bright pupil effect may be produced to help detect the position of the pupil of the eye. In other embodiments, the pupil may be located without the use of a bright pupil effect. At 712, method 700 further includes detecting a location of one or more reflections from the eye from the two-dimension image data. It will be understood that various techniques may be used to distinguish reflections arising from eye tracking light sources from reflections arising from environmental sources. For example, an ambient-only image may be acquired with all light sources turned off, and the ambient-only image may be subtracted from an image with the light sources on to remove environmental reflections from the image.

Method 700 further includes, at 714, determining a gaze direction of the eye from the location of the pupil and the location of reflections on the user's eye arising from the light sources. The reflection or reflections provide one or more references to which the pupil can be compared for determining a direction in which the eye is gazing.

At 716, method 700 includes determining a distance from the eye to a display. For example, the time-of-flight image data of the eye may be used to determine a distance from the eye to an image sensor in the depth camera. The distance from the eye to the image sensor may then be used to determine a distance along the gaze direction of the eye to the display. From this information, at 718, method 700 includes determining and outputting a location on a display at which the gaze direction intersects the display.

Thus, the disclosed embodiments may allow for a stable and accurate eye tracking system without the use of a stereo camera, and thus without the use of a large minimum baseline constraint that may be found with stereo camera systems. This may allow for the production of compact modular eye tracking systems that can be incorporated into any suitable device.

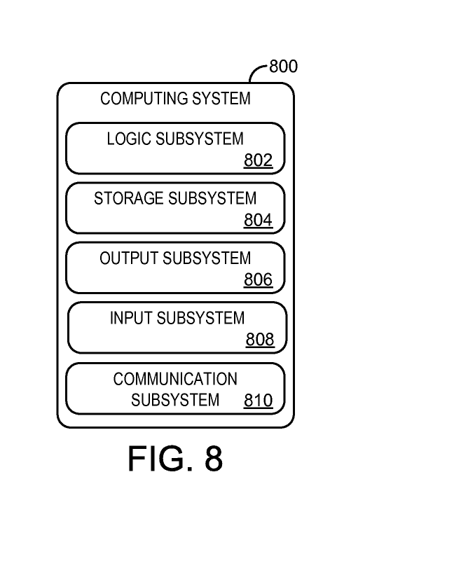

FIG. 8 schematically shows a non-limiting embodiment of a computing system 800 that can enact one or more of the methods and processes described above. Eye tracking module 500 and display device 120 may be non-limiting examples of computing system 800. Computing system 800 is shown in simplified form. It will be understood that virtually any computer architecture may be used without departing from the scope of this disclosure. In different embodiments, computing system 800 may take the form of a display device, wearable computing device (e.g. a head-mounted display device), mainframe computer, server computer, desktop computer, laptop computer, tablet computer, home-entertainment computer, network computing device, gaming device, mobile computing device, mobile communication device (e.g., smart phone), modular eye tracking device, etc.

Computing system 800 includes a logic subsystem 802 and a storage subsystem 804. Computing system 800 may optionally include an output subsystem 806, input subsystem 808, communication subsystem 810, and/or other components not shown in FIG. 8.

Logic subsystem 802 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, or otherwise arrive at a desired result.

The logic subsystem may include one or more processors configured to execute software instructions. Additionally or alternatively, the logic subsystem may include one or more hardware or firmware logic machines configured to execute hardware or firmware instructions. The processors of the logic subsystem may be single-core or multi-core, and the programs executed thereon may be configured for sequential, parallel or distributed processing. In some examples, logic subsystem may comprise a graphics processing unit (GPU). The logic subsystem may optionally include individual components that are distributed among two or more devices, which can be remotely located and/or configured for coordinated processing. Aspects of the logic subsystem may be virtualized and executed by remotely accessible, networked computing devices configured in a cloud-computing configuration.

Storage subsystem 804 includes one or more physical devices configured to hold data and/or instructions executable by the logic subsystem to implement the methods and processes described herein. When such methods and processes are implemented, the state of storage subsystem 804 may be transformed—e.g., to hold different data.

Storage subsystem 804 may include removable computer-readable media and/or built-in computer readable media devices. Storage subsystem 804 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard-disk drive, floppy-disk drive, tape drive, MRAM, etc.), among others. Storage subsystem 804 may include volatile, nonvolatile, dynamic, static, read/write, read-only, random-access, sequential-access, location-addressable, file-addressable, and/or content-addressable devices.

It will be appreciated that storage subsystem 804 includes one or more physical devices and excludes propagating signals per se. However, in some embodiments, aspects of the instructions described herein may be propagated by a pure signal (e.g., an electromagnetic signal, an optical signal, etc.) via a communications medium, as opposed to being stored on a storage device comprising a computer readable storage medium. Furthermore, data and/or other forms of information pertaining to the present disclosure may be propagated by a pure signal.

In some embodiments, aspects of logic subsystem 802 and of storage subsystem 804 may be integrated together into one or more hardware-logic components through which the functionally described herein may be enacted. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

When included, output subsystem 806 may be used to present a visual representation of data held by storage subsystem 804. This visual representation may take the form of a graphical user interface (GUI). As the herein described methods and processes change the data held by the storage subsystem, and thus transform the state of the storage subsystem, the state of output subsystem 806 may likewise be transformed to visually represent changes in the underlying data. Output subsystem 806 may include one or more display devices utilizing virtually any type of technology. Such display devices may be combined with logic subsystem 802 and/or storage subsystem 804 in a shared enclosure, or such display devices may be peripheral display devices.

When included, input subsystem 808 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 810 may be configured to communicatively couple computing system 800 with one or more other computing devices. Communication subsystem 810 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 800 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof

1. An eye tracking system, comprising:
a light source;
an image sensing subsystem configured to obtain a two-dimensional image of a user's eye and time-of-flight depth image data of a region that contains the user's eye;
a logic subsystem configured to
control the light source to emit light;
control the image sensing subsystem to acquire a two-dimensional image of the user's eye while emitting light via the light source;
control the image sensing subsystem to acquire a time-of-flight depth image of the user's eye;
determine a gaze direction of the user's eye from the two-dimensional image;
determine a location at which the gaze direction intersects the display based on the gaze location; and
output the location.

2. The system of claim 1, wherein the image sensing subsystem comprises a time-of-flight depth camera and a two-dimensional image sensor.

3. The system of claim 1, wherein the image sensing subsystem comprises a time-of-flight depth camera, and wherein the instructions are executable to detect a location of a pupil of the user's eye from image data acquired by the time-of-flight depth camera to determine the gaze direction of the user's eye.

4. The system of claim 1, wherein the system further comprises the display.

5. The system of claim 1, wherein the image sensing subsystem comprises a time-of-flight depth camera and the light source comprises a light source of the time-of-flight depth camera.

6. The system of claim 1, wherein the instructions are executable to detect a distance from the user's eye to the display along the gaze direction from the time-of-flight depth image to determine the location on the display at which the gaze direction intersects the display.

7. The system of claim 1, wherein the two-dimensional image is a first two-dimensional image, and wherein the instructions are further executable to:
control the image sensing subsystem to acquire a second two-dimensional image, the second two-dimensional image having a wider field of view than the first two-dimensional image, and
determine via the second two-dimensional image a location of the user's eye before determining the gaze direction of the user's eye from the first two-dimensional image.

8. The system of claim 7, wherein the image sensing subsystem comprises a time-of-flight depth camera, a higher resolution two-dimensional image sensor, and a lower resolution two-dimensional image sensor, and wherein the second two-dimensional image is acquired via the lower resolution two-dimensional image sensor and the first two-dimensional image is acquired via the higher resolution two-dimensional image sensor.

9. An eye tracking module, comprising:
a time-of-flight camera;
a light source;
a logic subsystem; and
a storage subsystem comprising instructions stored thereon that are executable by the logic subsystem to:
illuminate the light source;
acquire image data including an image of a user's eye while illuminating the light source and a time-of-flight depth image of the user's eye;
detect a location of a pupil of the user's eye and a location of a reflection in the user's eye from the image data;
determine a gaze direction of the user's eye from the location of the pupil and the location of the reflection; and
output a location on a display at which the gaze direction intersects the display based on the gaze direction and the time-of-flight depth image.

10. The module of claim 9, wherein the location of the pupil is detected via image data acquired by the time-of-flight image sensor.

11. The module of claim 9, further comprising a two-dimensional image sensor, and wherein the location of the pupil is detected via image data acquired via the two-dimensional image sensor.

12. The module of claim 9, wherein the module is coupled to a display device.

13. The module of claim 9, wherein the instructions are further executable to acquire an image of the user and determine via the image of the user a location of a region of a user containing the user's eye before determining the gaze direction of the user's eye.

14. The module of claim 9, wherein the body comprises a body of a mobile computing device.

15. The module of claim 9, wherein the body comprises a body of a wearable computing device.

16. On a mobile computing device, a method for tracking an eye of a user relative to a user interface displayed on a display, the method comprising illuminating a light source;
acquiring image data including an image of the eye while illuminating the light source;
acquiring depth data of the eye via a depth sensor having an unconstrained baseline distance;
detecting a location of a pupil of the eye and a location of a reflection of light from the light source on the eye from the image data;
determining a gaze direction of the eye from the location of the pupil and the location of the reflection;
detecting a distance from the eye to the display along the gaze direction from the depth data; and
outputting a location at which the gaze direction intersects the display.

17. The method of claim 16, wherein the depth sensor comprises a time-of-flight depth camera, and wherein the location of the pupil and the location of the reflection are detected via image data from the time-of-flight depth camera.

18. The method of claim 16, wherein the light source comprises a light source in a time-of-flight depth camera.

19. The method of claim 16, further comprising determining via the image data a location of the eye before determining the gaze direction of the eye.

20. The method of claim 16, wherein the image data is acquired from a time-of-flight depth camera.
